(19) United States
(12) Patent Application Publication
(10) Pub. No.: US 2026/0358050 A1
(43) Pub. Date: Nov. 12, 2026

(54) HELMET DRYER WITH CHARACTER MODELING STRUCTURE

(71) Applicant: Shenzhen Feika Technology Co.,LTD, Shenzhen (CN)

(72) Inventors: Yaqi LIU, Shenzhen (CN); Xinyu HU, Shenzhen (CN)

(73) Assignee: Shenzhen Feika Technology Co.,LTD, Shenzhen (CN)

(21) Appl. No.: 19/737,189

(22) Filed: Jul. 10, 2026

Related U.S. Application Data
(63) Continuation-in-part of application No. PCT/CN2025/124820, filed on Sep. 28, 2025.

(30) Foreign Application Priority Data
Sep. 30, 2024 (CN) 2024223981082

(51) Int. Cl. F26B 9/00; F26B 21/00; F26B 21/50

(52) U.S. Cl. CPC F26B 9/00; F26B 21/006; F26B 21/50

(57) ABSTRACT

The present utility model discloses a helmet dryer with a character modeling structure, comprising a helmet dryer main body, a character modeling structure, and a support base. The character modeling structure is disposed on the support base and internally defines a mounting cavity, where the helmet dryer main body is hided. A cover plate is fastened to the rear side of the character modeling structure and provided with a hollow groove. The air intake end of the helmet dryer main body communicates with the hollow groove, while the air outlet end faces the top of the character modeling structure to guide airflow into a helmet placed thereon. This design integrates helmet drying and decorative display functions. It shortens the air intake path, reduces air intake resistance, and improves drying efficiency.

### CROSS-REFERENCE TO RELATED APPLICATIONS

The application claims priority to Chinese patent application No. 2024223981082, filed on Sep. 30, 2024, the entire contents of which are incorporated herein by reference.

### TECHNICAL FIELD

The present utility model relates to a helmet dryer, and more particularly to a helmet dryer with a character modeling structure.

### BACKGROUND

With the rising popularity of motorcycle commuting, road cycling, skiing, roller skating, and other scenarios, helmets are being used more frequently. After being worn, exposed to rain, or cleaned, the liners, straps, and inner walls of a helmet tend to retain sweat and moisture. If kept damp for a prolonged period, the helmet will develop unpleasant odors and breed bacteria, which impairs wearing comfort and shortens the service life. Accordingly, drying devices are required to dry the interior of helmets.

Conventional helmet drying devices are generally composed of fans, heating elements, and support frames. Such devices adopt the appearance of ordinary household appliances or industrial equipment, which results in poor decorative performance and limits their application in home entryways, cycling stores and equipment display areas. Some existing products hide the drying components inside decorative housings to improve appearance; however, if the air intake structure is unreasonably designed, outside air has to flow into the housing cavity before being drawn into the fan. This will lead to an excessively long air intake path and high intake resistance, and may even generate negative pressure inside the housing. These issues increase fan load, reduce airflow, and degrade drying efficiency and operational stability. Therefore, there is an urgent demand for helmet dryer that integrates character modeling decorative features with an optimized air intake path to lower air intake resistance.

### SUMMARY

The technical problem to be solved by the present utility model is to provide a helmet dryer with a character modeling structure, so as to solve the problems existing in the background art.

The helmet dryer with a character modeling structure of the present utility model is realized through the following technical solution: it comprises a helmet dryer main body, a character modeling structure, and a support base. The character modeling structure is disposed on the support base, and a mounting cavity is formed inside the character modeling structure. The helmet dryer main body is disposed within the mounting cavity. The rear side of the character modeling structure is provided with an assembly opening communicating with the mounting cavity. A cover plate is fastened to the assembly opening. A hollow groove is disposed on the cover plate. The helmet dryer main body is provided with an air intake end and an air outlet end. The air intake end is aligned with the hollow groove and communicates with outside air via the hollow groove. The air outlet end faces the top of the character modeling structure, directing airflow into the interior of a helmet placed above the character modeling structure.

In a preferred technical solution, an air outlet is provided at the top of the character modeling structure. The air outlet communicates with the mounting cavity. The air outlet end of the helmet dryer main body is located below the air outlet and arranged vertically aligned with it.

In a preferred technical solution, the top of the character modeling structure forms a supporting area for bearing the helmet. The air outlet is located within or at the center of the supporting area, so that when the helmet is placed above the character modeling structure, the air outlet can deliver airflow into the helmet's inner cavity.

In a preferred technical solution, the cover plate covers the rear side of the character modeling structure and jointly encloses with the character modeling structure to form a mounting cavity. The hollow groove is disposed on the cover plate at a position corresponding to the air intake end of the helmet dryer main body.

In a preferred technical solution, the helmet dryer main body comprises a mounting bracket, a fan, a heating element bracket, a PTC ceramic heating element, and an air-collecting hood. The fan is mounted on the mounting bracket. The heating element bracket is disposed above the mounting bracket. The PTC ceramic heating element is mounted on the heating element bracket. The air-collecting hood is disposed above the heating element bracket and is aligned with the air outlet.

An ozone generator is also mounted on the side of the heating element bracket to play function of sterilization, disinfection and deodorization.

In a preferred technical solution, an air intake channel is provided at the bottom of the mounting bracket. The air inlet of the air intake channel is aligned with the hollow groove on the cover plate, and the air outlet side of the air intake channel faces the fan, so that outside air can enter the fan area via the hollow groove and the air intake channel.

In a preferred technical solution, the air intake channel is arranged obliquely relative to the mounting bracket, so that it can guide airflow from the rear air intake position to the fan position inside the character modeling structure.

In a preferred technical solution, the fan, the PTC ceramic heating element, and the air-collecting hood are arranged in sequence along the airflow direction. The fan sends air to the PTC ceramic heating element, and the air-collecting hood collects and directs the airflow heated by the PTC ceramic heating element toward the air outlet.

In a preferred technical solution, the air-collecting hood is disposed over the heating element bracket and provides a retaining function for it. The top of the air-collecting hood is aligned with the air outlet at the top of the character modeling structure.

In a preferred technical solution, a mounting seat is provided at one side of the mounting bracket. A circuit control board is provided at the mounting seat. The circuit control board is electrically connected to the fan, the ozone generator and the PTC ceramic heating element respectively. A control button is provided at the circuit control board, used to control the operating states of the fan, the ozone generator and the PTC ceramic heating element.

### Beneficial Effects

The present utility model hides the helmet dryer main body inside the character modeling structure. When a helmet is placed above the character modeling structure, it forms a visual effect of a figure wearing a helmet, achieving both drying function and enhanced decorative and display performance. Meanwhile, the hollow groove is arranged on the cover plate at the rear side of the character modeling structure and the air intake end is connected to the hollow groove via the air intake channel. This allows outside air to directly enter the fan area, which shortens the air intake path, reduces intake resistance and avoids excessive negative pressure inside the character modeling structure. As a result, fan load is reduced, and air intake stability is improved. The fan, PTC ceramic heating element, air-collecting hood, and air outlet are arranged in sequence along the airflow direction, enabling heated air to be delivered intensively into the interior of the helmet to dry the liners, straps, and inner walls in a targeted manner, which greatly improves drying efficiency and hot air utilization rate.

### BRIEF DESCRIPTION OF DRAWINGS

For a clearer description of the embodiments of the present utility model or the technical solutions in the prior art, the drawings required for describing the embodiments or the prior art are briefly introduced below. It is obvious that the drawings described below merely illustrate some embodiments of the present utility model; and those skilled in art can obtain other drawings based on these drawings without creative efforts.

FIG. 1 and FIG. 2 are perspective structural views of the present utility model;

FIG. 3 is a structural view of the helmet dryer main body of the present utility model;

FIG. 4 is a cross-sectional structural view of the helmet dryer main body of the present utility model;

FIG. 5 is an exploded structural view of the present utility model.

### DETAILED DESCRIPTION OF THE EMBODIMENTS

All features disclosed in this Description, or all steps in all methods or processes disclosed, may be combined in any manner, except for mutually exclusive features and/or steps.

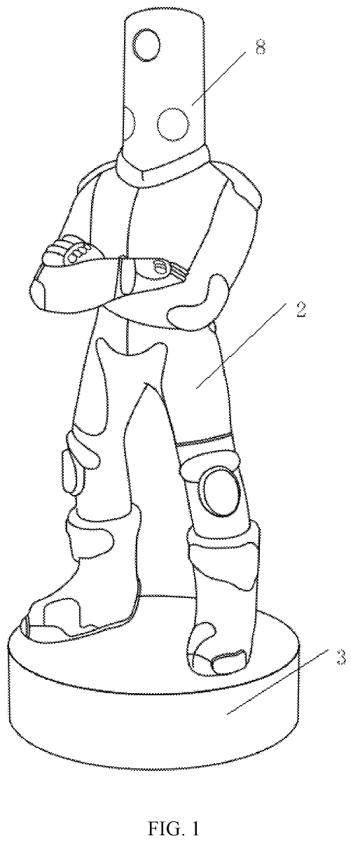

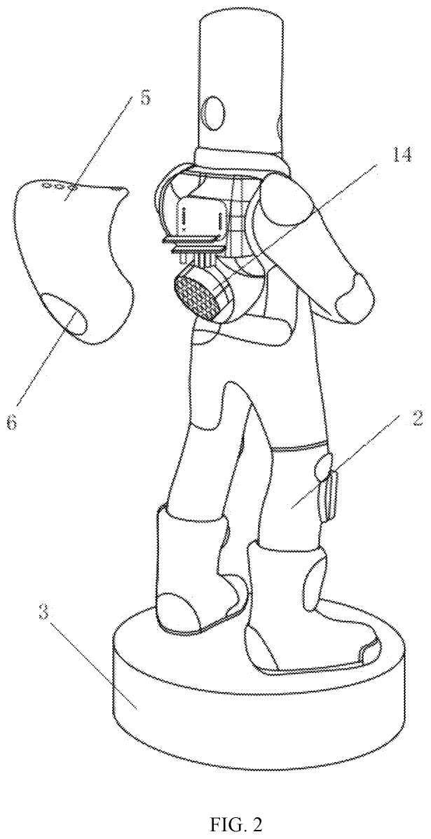

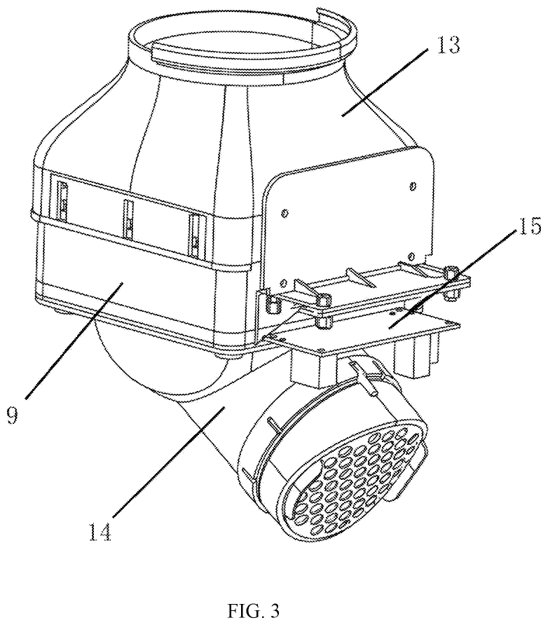

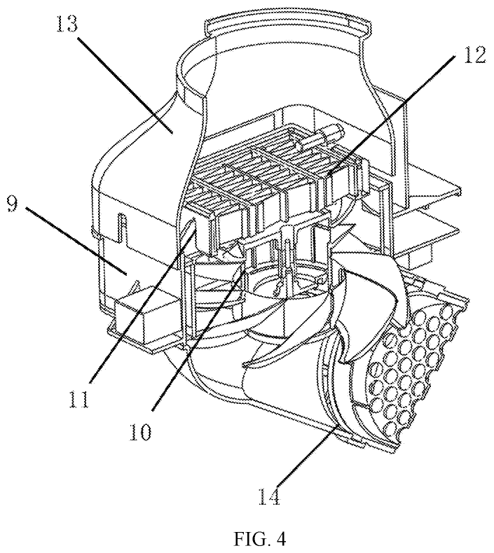

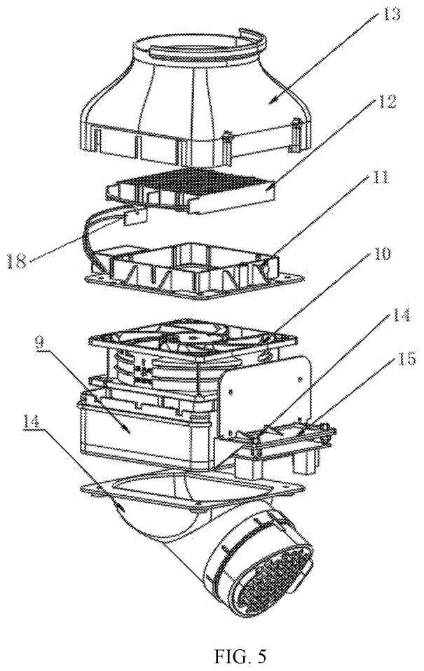

As shown in FIG. 1 to FIG. 5, the helmet dryer with a character modeling structure disclosed in this embodiment comprises a helmet dryer main body 1, a character modeling structure 2, and a support base 3. The support base 3 serves as the lower load-bearing structure of the whole device, supporting the character modeling structure 2 and the helmet dryer main body 1 disposed inside it. This ensures that when a helmet main body 8 is placed above the character modeling structure 2, the whole device remains stable and is unlikely to tip over due to the weight of the helmet main body 8 or offset placement.

The character modeling structure 2 is disposed on the support base 3. The character modeling structure 2 is shaped to simulate the outline of a human upper body, neck, or head support, so that when no helmet 8 is placed, the device itself has a decorative display effect. When the helmet main body 8 is placed above the character modeling structure 2, the helmet main body 8 and the character modeling structure 2 together form a visual effect of a figure wearing a helmet, so the device integrates helmet drying, display and decoration functions.

A mounting cavity 4 is formed inside the character modeling structure 2. The helmet dryer main body 1 is disposed within the mounting cavity 4, so that working components such as the fan 10, PTC ceramic heating element 12, and circuit control board 15 are hidden inside the character modeling structure 2 and not directly exposed externally. This hidden arrangement reduces the industrial appearance of conventional helmet drying devices where fans, heating elements, and brackets are exposed, resulting in a more complete overall look and better visual integration in home entryways, cycling shops, clubs, or sports equipment display areas.

A cover plate 5 is fastened to the rear side of the character modeling structure 2. The cover plate 5 seals the rear assembly area of the character modeling structure 2 and jointly encloses with the character modeling structure 2 to form the mounting cavity 4. During assembly, the helmet dryer main body 1 is first placed into the mounting cavity 4, and then the cover plate 5 is fastened to the rear side of the character modeling structure 2 to complete the hidden installation. The cover plate 5 adopts a detachable or openable fastening method, facilitating subsequent inspection, replacement, or cleaning of internal components such as the fan 10, PTC ceramic heating element 12, circuit control board 15, and air intake channel 14.

A hollow groove 6 is disposed on the cover plate 5, corresponding to the air intake end of the helmet dryer main body 1. When the cover plate 5 is fastened to the rear side of the character modeling structure 2, the air intake end of the helmet dryer main body 1 communicates with outside air via the hollow groove 6, allowing the outside air to enter directly from the rear side of the character modeling structure 2. Since the hollow groove 6 is disposed on the rear side, the air intake structure is hardly visible when users view the product from the front, helping to preserve the visual integrity of the front appearance of the character modeling structure 2, while also providing a continuous and stable air intake source for the helmet dryer main body 1.

An air outlet 7 is provided at the top of the character modeling structure 2, communicating with the mounting cavity 4. The air outlet end of the helmet dryer main body 1 is aligned with the air outlet 7. The air outlet 7 is preferably located in the area at the top of the character modeling structure 2 used to support the helmet main body 8. When the helmet main body 8 is placed upside-down or fitted over the character modeling structure 2, the air outlet 7 can guide airflow into the inner cavity of the helmet main body 8, allowing heated air to act directly on moisture-prone areas such as the liners, cushioning layers, straps, and inner walls, thereby improving drying efficiency.

Multiple air outlets are arranged, which are aligned respectively to the cheeks, forehead and the back of the head of the helmet for drying and sterilization.

The helmet dryer main body 1 comprises a mounting bracket 9, a fan 10, a heating element bracket 11, a PTC ceramic heating element 12, and an air-collecting hood 13. The mounting bracket 9 serves as the base mounting component, used to carry the fan 10, heating element bracket 11, PTC ceramic heating element 12, air-collecting hood 13, and related electronic control components, forming a stable assembly within the mounting cavity 4. The fan 10 is fixed on the mounting bracket 9. Its air intake side coordinates with the air intake direction at the rear side of the character modeling structure 2, and its discharge side faces the PTC ceramic heating element 12 and air-collecting hood 13, so as to draw in outside air and deliver it along a predetermined path.

An ozone generator 18 is also mounted on the side of the heating element bracket 11 to play function of sterilization, disinfection and deodorization.

The heating element bracket 11 is disposed above the mounting bracket 9. The PTC ceramic heating element 12 is fixed on the heating element bracket 11 and is located in the airflow path from the fan 10. When the fan 10 is operating, it delivers air to the area of the PTC ceramic heating element 12. The air passes through the PTC ceramic heating element 12 and is heated into hot air. The PTC ceramic heating element 12 features rapid warming and self-limiting temperature characteristics. It can meet helmet drying requirements while reducing the risk of overheating, making it suitable for drying helmet liners, fabric pads, and foam cushioning layers.

The air-collecting hood 13 is disposed above the heating element bracket 11 and the PTC ceramic heating element 12. It converges and directs heated airflow to prevent the hot air from dispersing randomly inside the mounting cavity 4 and guide the hot air intensively toward the air outlet 7 at the top of the character modeling structure 2. The top of the air-collecting hood 13 is aligned with the air outlet 7, and the lower end covers the outer side or top of the heating element bracket 11, so as to form a continuous air delivery channel between the fan 10, the PTC ceramic heating element 12, and the air outlet 7. This increases the effective volume of hot air entering the inner cavity of the helmet main body 8 and reduces heat loss.

In this embodiment, the air-collecting hood 13 also serves to retain the heating element bracket 11. After the heating element bracket 11 is installed above the mounting bracket 9, the air-collecting hood 13 is mounted over the heating element bracket 11 to limit the heating element bracket 11 in both the vertical and circumferential directions. This prevents displacement of the PTC ceramic heating element 12 caused by fan 10 vibration or device movement and ensures that the airflow from the fan 10 stably passes through the PTC ceramic heating element 12 and enters into the air-collecting hood 13.

The bottom of the mounting bracket 9 is provided with an air intake channel 14. The air intake end of the air intake channel 14 is aligned with the hollow groove 6 on the cover plate 5, and the air outlet side faces the air intake area of the fan 10. The air intake channel 14 guides outside air entering from the hollow groove 6 straight to the fan 10 and avoids random air dispersion inside the mounting cavity 4. The air intake channel 14 may be arranged obliquely relative to the mounting bracket 9. Such a structure enables a smooth transition from the air intake position on the rear side to the position of the fan 10 within the limited and irregular internal space of the character modeling structure 2, thereby shortening the air intake path and reducing the air intake resistance.

The fan 10, PTC ceramic heating element 12, air-collecting hood 13, and air outlet 7 are arranged in sequence along the airflow direction, forming an airflow path where air enters from the rear, is heated internally and exits from the upper end. During operation, when the fan 10 starts, outside air enters via the hollow groove 6 on the cover plate 5, is guided to the air intake area of the fan 10 via the air intake channel 14, and is then sent by the fan 10 to the PTC ceramic heating element 12. The air is heated and enters the air-collecting hood 13, where it is collected and discharged through the air outlet 7. When the helmet main body 8 is placed above the character modeling structure 2, the hot air enters the inner cavity of the helmet main body 8 through the air outlet 7, continuously blowing over damp areas inside to achieve drying.

A mounting seat 17 is disposed on one side of the mounting bracket 9. A circuit control board 15 is provided at the mounting seat 17. The circuit control board 15 is electrically connected to the fan 10 and the PTC ceramic heating element 12 respectively, and is used to control the start, stop, and operating states of the fan 10 and the PTC ceramic heating element 12. The circuit control board 15 is disposed on one side of the mounting bracket 9, so that it can avoid the main airflow heating channel. This reduces the direct impact of hot air on the circuit control board 15 and facilitates the wiring between the circuit control board 15, the fan 10, and the PTC ceramic heating element 12. The mounting seat 17 supports and fixes circuit control board 15, to prevent internal displacement in the mounting cavity 4 and improve overall operational stability.

The circuit control board 15 is provided with control buttons 16, which are used by users to operate and control the helmet dryer. When a user presses the control button 16, the circuit control board 15 controls the fan 10, the ozone generator 18 and PTC ceramic heating element 12 according to the button signal. For example, when the drying function is activated, the fan 10, the ozone generator 18 and PTC ceramic heating element 12 operate simultaneously; when the drying function is turned off, all three stop. In practical application, the control buttons 16 can also be configured as single-key control, multi-level control or timing control according to product requirements, to meet the drying demands of helmet main bodies 8 with different moisture levels.

In use, a user places the helmet main body 8 on the character modeling structure 2, with the inner cavity of the helmet main body 8 facing the air outlet 7, then activates the device via the control button 16. Outside air enters via the hollow groove 6, is sent to the fan 10 via the air intake duct 14, and then delivered by the fan 10 to the PTC ceramic heating element 12 for heating. The heated air is gathered by the air-collecting hood 13 and flows into the helmet main body 8 through the air outlet 7. As the hot air circulates in the inner cavity of the helmet main body 8, it carries away moisture from the liners, straps, and inner wall surfaces, gradually restoring the helmet main body 8 to a dry state.

In this embodiment, the helmet dryer main body 1 is hided inside the mounting cavity 4 of the character modeling structure 2; and the rear side is sealed by the cover plate 5 to form an integrated character modeling structure 2 in appearance. Meanwhile, the hollow groove 6, air intake channel 14, fan 10, PTC ceramic heating element 12, air-collecting hood 13, and air outlet 7 form a continuous and reasonable airflow path, so air can enter from the rear side and be intensively discharged from the top, to realize targeted drying inside the helmet main body 8. The support base 3 ensures stable placement of the whole device. The cover plate 5 facilitates assembly and daily maintenance of internal parts. The mounting bracket 9 guarantees reliable installation of all functional components. The circuit control board 15 and control button 16 enable simple operation. As a result, this helmet dryer combines compact structure, attractive appearance, clear airflow routing, high drying efficiency, and convenient maintenance.

What is claimed is:

1. A helmet dryer with a character modeling structure, wherein it comprises a helmet dryer main body (1), a character modeling structure (2), and a support base (3); the character modeling structure (2) is disposed on the support base (3), a mounting cavity (4) is formed inside the character modeling structure (2), and the helmet dryer main body (1) is disposed within the mounting cavity (4); a cover plate (5) is fastened to the rear side of the character modeling structure (2), the cover plate (5) is provided with a hollow groove (6), the helmet dryer main body (1) is provided with an air intake end and an air outlet end, the air intake end is aligned with the hollow groove (6) and communicates with outside air via the hollow groove (6), and the air outlet end faces the top of the character modeling structure (2) to guide airflow into the interior of a helmet main body (8) placed on the character modeling structure (2).

2. The helmet dryer with a character modeling structure according to claim 1, wherein an air outlet (7) is provided at the top of the character modeling structure (2), the air outlet (7) communicates with the mounting cavity (4), and the air outlet end of the helmet dryer main body (1) is located below the air outlet (7) and arranged vertically aligned with the air outlet (7).

3. The helmet dryer with a character modeling structure according to claim 2, wherein the top of the character modeling structure (2) forms a support region for bearing the helmet main body (8), the air outlet (7) is provided in the support region, so that when the helmet main body (8) is placed above the character modeling structure (2), the air outlet (7) can guide airflow into the inner cavity of the helmet main body (8).

4. The helmet dryer with a character modeling structure according to claim 1, wherein the cover plate (5) covers the rear side of the character modeling structure (2) and jointly encloses with the character modeling structure (2) to form the mounting cavity (4), and the hollow groove (6) is provided at the cover plate (5) at a position corresponding to the air intake end of the helmet dryer main body (1).

5. The helmet dryer with a character modeling structure according to claim 4, wherein the helmet dryer main body (1) comprises a mounting bracket (9), a fan (10), a heating element bracket (11), a PTC ceramic heating element (12), and an air-collecting hood (13); the fan (10) is mounted on the mounting bracket (9), the heating element bracket (11) is arranged above the mounting bracket (9), the PTC ceramic heating element (12) is mounted on the heating element bracket (11), and the air-collecting hood (13) is arranged above the heating element bracket (11) and is aligned with the air outlet (7);
An ozone generator (18) is also mounted on the side of the heating element bracket (11) to play function of sterilization, disinfection and deodorization.

6. The helmet dryer with a character modeling structure according to claim 5, wherein an air intake channel (14) is provided at the bottom of the mounting bracket (9), the air inlet of the air intake channel (14) is aligned with the hollow groove (6) on the cover plate (5), and the air outlet side of the air intake channel (14) faces the fan (10), so that outside air can enter the area where the fan (10) is located via the hollow groove (6) and the air intake channel (14).

7. The helmet dryer with a character modeling structure according to claim 6, wherein the air intake channel (14) is arranged obliquely relative to the mounting bracket (9), so that the air intake channel (14) can guide airflow from the rear air intake position to the fan (10) inside the character modeling structure (2).

8. The helmet dryer with a character modeling structure according to claim 5, wherein the fan (10), the PTC ceramic heating element (12), and the air-collecting hood (13) are arranged in sequence along the airflow direction; the fan (10) is designed to deliver airflow toward the PTC ceramic heating element (12), and the air-collecting hood (13) is designed to converge heated airflow from the PTC ceramic heating element (12) and direct the airflow toward the air outlet (7).

9. The helmet dryer with a character modeling structure according to claim 5, wherein the air-collecting hood (13) is disposed over the heating element bracket (11) and functions to retain the heating element bracket (11), and the top of the air-collecting hood (13) is aligned with the air outlet (7) at the top of the character modeling structure (2).

10. The helmet dryer with a character modeling structure according to claim 5, wherein one side of the mounting bracket (9) is provided with a mounting seat (17), a circuit control board (15) is provided at the mounting seat (17), the circuit control board (15) is electrically connected to the fan (10), the ozone generator (18) and the PTC ceramic heating element (12) respectively, a control button (16) is provided at the circuit control board (15) for controlling the operating states of the fan (10), the ozone generator (18) and the PTC ceramic heating element (12).
